(19) United States
(12) Patent Application Publication
(10) Pub. No.: US 2026/0111774 A1
(43) Pub. Date: Apr. 23, 2026

(54) DYNAMIC EVALUATION OF SERVERLESS FUNCTIONS FOR QUANTUM COMPUTING ENVIRONMENTS

(71) Applicant: Red Hat, Inc., Raleigh, NC (US)

(72) Inventors: Stephen Coady, Dublin (IE); Leigh Griffin, Waterford (IE)

(21) Appl. No.: 18/920,551

(22) Filed: Oct. 18, 2024

(51) Int. Cl. G06N 10/20

(52) U.S. Cl. CPC G06N 10/20

(57) ABSTRACT

A Quantum Instruction (QI) file comprising a proposed serverless quantum function for a particular quantum computing environment is obtained. Quantum serverless scoring information descriptive of a plurality of quantum scoring criteria for serverless quantum functions executed within the particular quantum computing environment is accessed. Based on the plurality of quantum scoring criteria, a suitability score for the proposed serverless quantum function is computed, wherein the suitability score is specific to the particular quantum computing environment. Based on the suitability score, an execution action is performed for the proposed serverless quantum function.

### BACKGROUND

Cloud computing platforms provide on-demand access to a shared pool of configurable computing resources (e.g., servers, computing devices, storage, networking infrastructure, etc.). Cloud computing platforms enable users to leverage computing power and storage without the need to own or maintain physical hardware. Conventionally, cloud computing platforms are structured so that resources can be allocated to users based on need using virtualization technologies and the like. For example, if a user hosts a website on a cloud computing platform, and the website receives a spike in web traffic, additional resources (e.g., compute power, network infrastructure, virtualized network devices, etc.) can be dynamically allocated to the website during the traffic spike and then de-allocated once the traffic spike is over. In this manner, cloud computing platforms can offer scalability, flexibility, and cost-efficiency to users.

Serverless computing is an advancement within the cloud computing paradigm that abstracts the underlying infrastructure from developers entirely. In a serverless model, developers can deploy functions or small units of code that are executed in response to specific events, such as HTTP requests or database changes. The cloud provider automatically handles all aspects of infrastructure management, including scaling, provisioning, and maintaining servers. Serverless computing offers a pay-per-use billing model, meaning users only incur costs for the actual compute time consumed during function execution, rather than for idle server capacity. This model allows for highly efficient resource utilization and simplifies the development and deployment process by enabling developers to focus solely on application logic.

### SUMMARY

A Quantum Instruction (QI) file can include a proposed serverless quantum function. The QI file can be obtained by a quantum computing system within a first quantum computing environment. The quantum computing system can access quantum scoring criteria for serverless quantum functions executed within the first quantum computing environment. Based on the plurality of quantum scoring criteria, the quantum computing system can compute a suitability score for the proposed serverless quantum function. Based on the suitability score, the quantum computing system can select an execution action to perform for the proposed serverless quantum function

In one implementation, a method is provided. The method includes obtaining, by a quantum computing system comprising one or more processor devices, a Quantum Instruction (QI) file comprising a proposed serverless quantum function for a first quantum computing environment. The method further includes accessing, by the quantum computing system, first quantum serverless scoring information descriptive of a plurality of first quantum scoring criteria for serverless quantum functions executed within the first quantum computing environment. The method further includes, based on the plurality of first quantum scoring criteria, computing, by the quantum computing system, a first suitability score for the proposed serverless quantum function, wherein the first suitability score is specific to the first quantum computing environment. The method further includes, based on the first suitability score, performing, by the quantum computing system, an execution action for the proposed serverless quantum function.

In another implementation, a quantum computing system is provided. The quantum computing system includes a memory, and one or more processor devices coupled to the memory. The one or more processor devices are to obtain a QI file comprising a proposed serverless quantum function for a first quantum computing environment. The one or more processor devices are further to access first quantum serverless scoring information descriptive of a plurality of first quantum scoring criteria for serverless quantum functions executed within the first quantum computing environment. The one or more processor devices are further to, based on the plurality of first quantum scoring criteria, compute a first suitability score for the proposed serverless quantum function, wherein the first suitability score is specific to the first quantum computing environment. The one or more processor devices are further to, based on the first suitability score, perform an execution action for the proposed serverless quantum function.

In another implementation, a non-transitory computer-readable storage medium is provided. The non-transitory computer-readable storage medium includes executable instructions to cause one or more processor devices of a quantum computing system to obtain a QI file comprising a proposed serverless quantum function for a first quantum computing environment. The instructions further cause the one or more processor devices to access first quantum serverless scoring information descriptive of a plurality of first quantum scoring criteria for serverless quantum functions executed within the first quantum computing environment. The instructions further cause the one or more processor devices to, based on the plurality of first quantum scoring criteria, compute a first suitability score for the proposed serverless quantum function, wherein the first suitability score is specific to the first quantum computing environment. The instructions further cause the one or more processor devices to, based on the first suitability score, perform an execution action for the proposed serverless quantum function.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing environment suitable for automated operators for construction of declarative interfaces from imperative interfaces according to some implementations of the present disclosure.

FIG. 2 is a data flow diagram for evaluating the proposed serverless function with a machine-learned model according to some implementations of the present disclosure.

FIG. 3 is a flowchart diagram illustrating operations performed by the quantum computing system of FIG. 1 for dynamic evaluation of serverless functions for quantum computing environments, according to one example.

FIG. 4 is a block diagram of the computing device of FIG. 1 for dynamic evaluation of serverless functions for quantum computing environments, according to one example.

FIG. 5 is a block diagram of the quantum computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Cloud computing platforms provide on-demand access to a shared pool of configurable computing resources (e.g., servers, computing devices, storage, networking infrastructure, etc.). Cloud computing platforms enable users to leverage computing power and storage without the need to own or maintain physical hardware. Conventionally, cloud computing platforms are structured so that resources can be allocated to users based on need using virtualization technologies and the like. For example, if a user hosts a website on a cloud computing platform, and the website receives a spike in web traffic, additional resources (e.g., compute power, network infrastructure, virtualized network devices, etc.) can be dynamically allocated to the website during the traffic spike and then de-allocated once the traffic spike is over. In this manner, cloud computing platforms can offer scalability, flexibility, and cost-efficiency to users.

Serverless computing is an advancement within the cloud computing paradigm that abstracts the underlying infrastructure from developers entirely. In a serverless model, developers can deploy functions or small units of code that are executed in response to specific events, such as HTTP requests or database changes. The cloud provider automatically handles all aspects of infrastructure management, including scaling, provisioning, and maintaining servers. Serverless computing offers a pay-per-use billing model, meaning users only incur costs for the actual compute time consumed during function execution, rather than for idle server capacity. This model allows for highly efficient resource utilization and simplifies the development and deployment process by enabling developers to focus solely on application logic.

As described herein, the term “serverless” refers to a type of software execution environment in which execution of software instructions is event-driven and managed entirely by a cloud computing platform that implements the software execution environment. A serverless function refers to a unit of software instructions (e.g., lines of code, functions, procedures, modules, processes, applications, services, etc.) configured for serverless execution environments. Serverless functions are typically stateless, meaning that each function invocation (i.e., execution) is independent with no information persisting between invocations. Furthermore, serverless functions are typically event-driven, meaning that they can be invoked in response to the occurrence of an event.

In the serverless model, code is executed in response to events, such as requests, database modifications, message queue triggers, or other predefined occurrences. When an event occurs, the cloud computing platform can dynamically allocate computing resources to execute a serverless function. The infrastructure, including server provisioning, scaling, load balancing, and system maintenance, is fully abstracted from the entity that creates the function. Costs for serverless architectures are calculated based on the compute time and resources utilized during the execution of a serverless function, rather than for pre-allocated or reserved resources. This model provides efficient resource management and is particularly advantageous for applications with unpredictable or variable workloads.

For example, take a scenario in which an image is uploaded by a user for processing. In a server-based execution environment, computing resources can be allocated to a virtual machine instance that includes an image processing function. The virtual machine can receive and process the image with the image processing application, and then provide an output. Once complete, the virtual machine and the allocated computing resources can remain idle until the next request is received. Conversely, in a serverless execution environment, the receipt of the image can cause an event-driven instantiation of a serverless image processing function and dynamic allocation of the computing resources necessary to execute the function. Once execution is complete, the computing resources are de-allocated. In such fashion, serverless execution environments can substantially improve computing resource efficiency.

The resource efficiency improvements enabled by serverless execution environments have led to increased popularity of serverless architectures for fields in which computing resources are scarce. In particular, the field of quantum computing is strongly resource-constrained due to the difficulty and expense of creating and maintaining qubits, and as such, is a strong candidate to benefit from the efficiency improvements offered by serverless execution environments.

However, designing serverless functions for quantum computing systems can present different and unexpected challenges in comparison to classical computing systems (e.g., geographically distributed qubits and associated latency, extreme resource scarcity, etc.). Furthermore, serverless functions that are not designed carefully can overuse qubits in quantum computing environments, which can be substantially disruptive. As such, there is a need to evaluate serverless functions prior to execution in a quantum computing environment.

Accordingly, implementations described herein propose dynamic evaluation of serverless functions for quantum computing environments. More specifically, a quantum computing system can obtain a Quantum Instruction (QI) file (e.g., a Quantum Assembly Language (QASM) file, etc.) that includes a proposed serverless quantum function for a particular quantum computing environment. Specifically, the proposed serverless quantum function can be created for a specific quantum computing environment that includes specific quantum computing resources.

The computing system can access quantum serverless scoring information that describes a plurality of quantum scoring criteria. These quantum scoring criteria can be for scoring serverless quantum functions executed within the particular quantum computing environment. The quantum serverless scoring information can also include different quantum scoring criteria for other quantum execution environments. As such, the quantum scoring criteria can be specifically tailored to the particular quantum computing environment.

For example, assume that the particular quantum computing environment includes a large number of available qubits, but each qubit is located in a different geographic location. The quantum scoring criteria for that particular quantum computing environment may include a latency sensitivity criteria (and/or weight the criteria heavily) due to the distributed nature of the qubits within the quantum computing environment. Conversely, the quantum scoring criteria may exclude a resource availability criteria (or weight the criteria lightly) due to the large quantity of quantum computing resources available within the environment.

The quantum computing system can compute a suitability score for the proposed serverless quantum function based on the plurality of quantum scoring criteria. The suitability score can be specific to the particular quantum computing environment. More specifically, the suitability score can indicate a degree of suitability for execution of the serverless function within the particular quantum computing environment. To follow the previous example, if the serverless function is not sensitive to qubit latency, and requires a large quantity of available qubits, the suitability score is likely to indicate that the proposed serverless quantum function is suitable for execution within the particular quantum computing environment.

Based on a comparison between the suitability score and a first threshold suitability score, the quantum computing system can perform an execution action for the proposed serverless quantum function. The execution action can include executing the proposed serverless quantum function, modifying the proposed serverless quantum function, outputting an indication related to the proposed serverless quantum function to a user, etc. In such fashion, implementations described herein can be utilized to determine the suitability of a proposed serverless quantum function prior to execution of the function within a particular quantum computing environment.

Aspects of the present disclosure provide a number of technical effects and benefits. As one example, implementations described herein reduce the use of computing resources associated with executing serverless functions in quantum computing environments for which the serverless functions are unsuited. For example, executing a serverless function that is unsuitable for a particular quantum computing environment can substantially degrade performance due to resource over-allocation, resource over-usage, etc. However, implementations described herein can identify whether a serverless function is suitable for a particular quantum computing environment. If a serverless function is found to be unsuitable, the serverless function can be modified or a more suitable quantum computing environment can be selected, thus mitigating a cause of performance degradation.

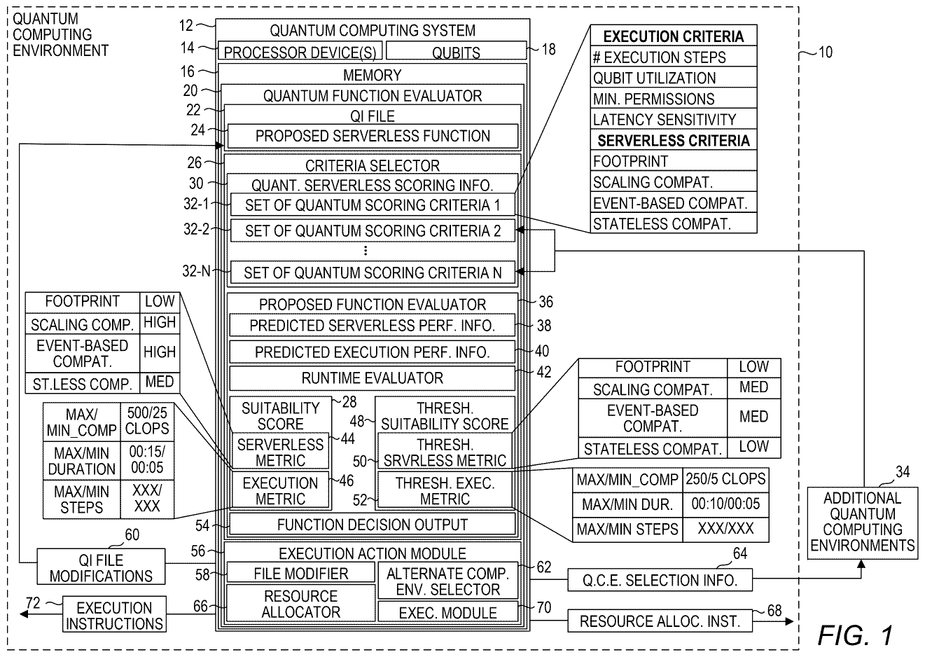

FIG. 1 is a block diagram of a quantum computing environment 10 suitable for automated operators for construction of declarative interfaces from imperative interfaces according to some implementations of the present disclosure. A quantum computing environment 10 can include a quantum computing system 12 with one or more processor device(s) 14 and a memory 16. As described herein, the “computing environment” 10 can be any type or manner of computing environment (e.g., a collection of computing devices, systems, and related infrastructure associated with a particular entity or organization), such as a “confidential” computing environment in which sensitive data and code is protected during processing, a “public” computing environment, etc. For example, the quantum computing environment 10 can be or otherwise include a confidential computing “enclave” that leverages hardware-based TEEs and secure virtualization technologies, such as memory encryption, to isolate critical computations and prevent unauthorized access to data while in use. For another example, the quantum computing environment 10 can be a distributed computing environment that utilizes computing resources across a variety of different types of devices (e.g., servers, virtualized devices, user devices, Internet-of-Things (IoT) devices, etc.).

The quantum computing environment 10 can refer to a logical grouping, or clustering, of computing systems, devices, and/or resources. More specifically, the quantum computing environment 10 is an environment in which a number of separate devices and/or systems share resources (e.g., hardware resources, compute cycles, services, etc.) via a central management framework that enforces consistent configuration and policies. It should be noted that the quantum computing environment 10 can include any type or manner of computing device or system. For example, in some implementations, the quantum computing environment 10 can include a number of quantum computing systems and classical computing systems. Additionally, in some implementations, the quantum computing environment 10 can include quantum computing devices that can implement and measure quantum processes. For example, the quantum computing device(s) can include hardware and/or software resources that implement quantum processes by maintaining photon(s) in superposition.

The quantum computing system 12 can operate in the quantum computing environment 10 but can operate using classical computing principles and/or quantum computing principles. In some implementations, the quantum computing system 12 may be a computing system that includes multiple computing devices (e.g., classical computing devices, quantum computing devices, etc.). Alternatively, in some implementations, the quantum computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In some implementations, the quantum computing environment 10 can include multiple types of nodes. As described herein, a “node” generally refers to a discrete unit of hardware and/or software resources. In some instances, nodes within the quantum computing environment 10 can be configured to perform specific tasks. For example, some nodes within the quantum computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

In some implementations, the quantum computing environment 10 can be, or otherwise include, a software development environment. The quantum computing environment 10 can include computing device(s), system(s), etc. that are utilized for developing software. For example, the quantum computing system 12 can be a system for creating (i.e., developing) and/or maintaining a large software project (e.g., an application. To do so, the quantum computing system 12 may maintain a codebase for the large software project, a code versioning system and/or versioning information for the codebase, etc.

The quantum computing system 12 can implement, include, or otherwise access qubits 18. It should be noted that, in some implementations, one or more of the qubits 18 may be located on a quantum computing device or system located remotely from the quantum computing system 12. For example, some of the qubits 18 may be components of, and located at, the quantum computing system 12 while other qubits of the qubits 18 are located at remote quantum computing devices. Such quantum computing devices may allocate remote qubit(s) to serve as one (or more) of the qubits 18. The remote qubit(s) can process information remotely at the quantum computing devices, which may in turn communicate processed information to the quantum computing system 12 (e.g., via one or more networks, etc.). In such fashion, the quantum computing system 12 may increase a quantum processing capacity by leveraging remotely located qubits.

The memory 16 of the quantum computing system 12 can include a qubit registry that maintains state information about the qubits 18, including, by way of non-limiting example, a total qubits counter that identifies the total number of qubits 18 implemented by the quantum computing system 12, a total available qubits counter that maintains count of the total number of qubits 18 that are currently available for allocation, etc. In some implementations, the remote qubits can be located at different locations.

The memory 16 of the quantum computing system 12 can include a quantum function evaluator 20. The quantum function evaluator 20 can evaluate a proposed serverless quantum function (e.g., software instructions that implement the proposed serverless quantum function, an executable comprising the function, etc.) for the quantum computing environment 10. In particular, the quantum function evaluator 20 can evaluate whether a proposed serverless quantum function is suitable for the quantum computing environment 10.

To do so, the quantum function evaluator 20 can obtain a Quantum Instruction (QI) file 22. The QI file 22 can include any type or manner of assembly-based quantum instructions, such as instructions written in QASM or the like. In particular, the QI file 22 can include a proposed quantum serverless function 24. The proposed quantum serverless function 24 can be a quantum serverless function proposed for execution within the quantum computing environment 10 (e.g., using the qubits 18, etc.). The quantum function evaluator 20 can obtain or otherwise access the QI file 22 to evaluate the proposed quantum serverless function 24.

The quantum function evaluator 20 can include a criteria selector 26. The criteria selector 26 can select criteria to evaluate to use in computing a suitability score 28 for the proposed quantum serverless function 24. The suitability score 28 can indicate whether the proposed quantum serverless function 24 is suitable for execution within the quantum computing environment 10. For example, the suitability score 28 can be a binary variable (e.g., a “yes/no” suitability decision). For another example, the suitability score 28 can indicate a degree of suitability (e.g., a scalar value) and/or can include a plurality of sub-scores.

The criteria selector 26 can access (or otherwise include) quantum serverless scoring information 30. The quantum serverless scoring information 30 can include sets of quantum scoring criteria 32-1-32-N (generally, sets of quantum scoring criteria 32). Each of the sets of quantum scoring criteria 32 can be scoring criteria for a particular quantum computing environment. In other words, each of the sets of quantum scoring criteria 32 can be specifically tailored to a corresponding quantum computing environment. For example, the set of quantum scoring criteria 32-1 can be scoring criteria for the quantum computing environment 10. The sets of quantum scoring criteria 32-2-32-N can be quantum scoring criteria for additional quantum computing environments 34.

In some implementations, the additional quantum computing environments 34 can be external to the quantum computing environment 10. For example, the additional quantum computing environments 34 can be implemented by different entity(s) or organization(s) than those which implement the quantum computing environment 10. For another example, the additional quantum computing environments 34 can include different quantum computing resources than those of the quantum computing environment 10. In some implementations, the additional quantum computing environments 34 can be included in the quantum computing environment 10. For example, the additional quantum computing environments 34 can be sub-environments or portions of the quantum computing environment 10.

The sets of quantum scoring criteria 32 can include any type or manner of quantum scoring criteria, such as a number of execution steps, predicted degree of qubit utilization, access permissions, latency sensitivity, footprint, scaling compatibility, event-based compatibility, etc. In some implementations, a quantum scoring criterion can indicate a particular technique or metric by which the quantum scoring criterion is to be evaluated. For example, a quantum scoring criterion for computational complexity associated with the proposed quantum serverless function 24 may evaluate a number of nested loops, a number of lines of code, etc. For another example, a quantum scoring criterion for stateless compatibility may evaluate whether state information is stored or retrieved during invocation of the proposed quantum serverless function 24.

The quantum function evaluator 20 can include a proposed function evaluator 36. The proposed function evaluator 36 can evaluate the set of quantum scoring criteria 32-1 to generate the suitability score 28 for the proposed quantum serverless function 24. Specifically, in some implementations, the set of quantum scoring information 30 can include execution-related criteria (also referred to herein as execution criteria) and serverless-related criteria (also referred to herein as serverless criteria). To follow the depicted example, the set of quantum scoring criteria 32-1 can include execution criteria such as a number of execution steps performed during invocation of the proposed quantum serverless function 24, qubit utilization by the proposed quantum serverless function 24, security permissions required to execute the proposed quantum serverless function 24, latency sensitivity of the proposed quantum serverless function 24 during execution, etc. The set of quantum scoring criteria 32-1 can also include serverless criteria such as an overall “footprint” (e.g., hardware resources, software resources, services, etc. required to invoke the proposed quantum serverless function 24, etc.).

In some implementations, the proposed function evaluator 36 can generate predicted serverless performance information 38 when evaluating the serverless criteria included in the set of quantum scoring criteria 32-1. The predicted serverless performance information 38 can describe predicted serverless-related performance metrics for the proposed quantum serverless function 24 (e.g., overall “footprint,” scaling compatibility, event-based compatibility, stateless compatibility, etc.). For example, assume that the set of quantum scoring criteria 32-1 includes a criterion for scaling compatibility. The proposed function evaluator 36 can evaluate the scaling compatibility of the proposed quantum serverless function 24 (e.g., by analyzing the QI file 22, by scaling the proposed quantum serverless function 24 in a test environment, etc.). The predicted serverless performance information 38 can include the results of the evaluation of the scaling compatibility by the proposed function evaluator 36.

In some implementations, the proposed function evaluator 36 can generate predicted execution performance information 40 when evaluating the execution criteria included in the set of quantum scoring criteria 32-1. The predicted execution performance information 40 can describe predicted execution-related performance metrics for the proposed quantum serverless function 24 (e.g., number of execution steps, qubit utilization, minimum permissions, latency sensitivity, etc.). For example, assume that the set of quantum scoring criteria 32-1 includes a criterion for qubit utilization. The proposed function evaluator 36 can evaluate the qubit utilization of the proposed quantum serverless function 24 (e.g., by analyzing the QI file 22, by executing the proposed quantum serverless function 24 in a test environment, etc.). The predicted execution performance information 40 can include the results of the evaluation of the scaling compatibility by the proposed function evaluator 36.

In some implementations, the proposed function evaluator 36 can include a runtime evaluator 42. The runtime evaluator 42 can evaluate an initial invocation or a historic invocation of the proposed quantum serverless function 24 to generate performance information for the proposed quantum serverless function 24. In some implementations, the runtime evaluator can evaluate performance of the proposed quantum serverless function 24 in real-time and compare the real-time performance measurements to the predicted serverless performance information 38 and/or the predicted execution performance information 40. Based on the comparison, the quantum function evaluator 20 may perform an execution action (e.g., modifying the proposed quantum serverless function based on a difference between the

The proposed function evaluator 36 can generate the suitability score 28 based on the set of quantum scoring criteria 32-1. For example, the proposed function evaluator 36 can generate the suitability score 28 based on the results of evaluating the set of quantum scoring criteria 32-1 (e.g., the predicted serverless performance information 38, the predicted execution performance information 40, etc.). In some implementations, the suitability score 28 can include a serverless metric 44 and an execution metric 46. The execution metric 46 can indicate a degree of suitability for executing the proposed quantum serverless function 24 within the quantum computing environment 10. The serverless metric 44 can indicate a degree of suitability for serverless implementation of the proposed quantum serverless function 24. For example, the execution metric 46 may indicate that the proposed quantum serverless function 24 is highly suited for execution within the quantum computing environment 10 based on the predicted execution performance information 40 (or some other results from an execution-based evaluation of the set of quantum scoring criteria 32-1). However, the serverless metric 44 may indicate that the proposed quantum serverless function 24 is poorly suited for serverless implementation within the quantum computing environment (e.g., based on the predicted serverless performance information 38).

In some implementations, the proposed function evaluator 36 can include a threshold suitability score 48. The proposed function evaluator 36 can compare the threshold suitability score 48 to the suitability score 28. Specifically, in some implementations, the threshold suitability score 48 can include a threshold serverless metric 50 and a threshold execution metric 52. The proposed function evaluator 36 can compare the suitability score 28 to the threshold suitability score 48. For example, the proposed function evaluator 36 can compare the serverless metric 44 to the threshold serverless metric 50, the execution metric 46 to the threshold execution metric 52, etc. In some implementations, the threshold suitability score 48 can be a scalar value and the proposed function evaluator 36 can determine whether the suitability score 28 is greater than, less than, equal to, etc. the threshold suitability score 48.

The proposed function evaluator 36 can generate a function decision output 54. The function decision output 54 can indicate that the proposed quantum serverless function 24 is either suitable for execution or unsuitable for execution within the quantum computing environment 10. The function decision output 54 can indicate a selected execution action from a plurality of candidate execution actions for the proposed quantum serverless function 24. In some implementations, the function decision output 54 can be generated based on the comparison between the suitability score 28 and the threshold suitability score 48. Additionally, or alternatively, in some implementations, the function decision output 54 can be generated based on the suitability score 28, the serverless metric 44, the execution metric 46, etc.

More specifically, the quantum function evaluator 20 can include an execution action module 56. The execution action module 56 can perform an execution action for the proposed quantum serverless function 24 based on the suitability score 28. As described herein, an “execution action” can describe any action(s), operations, or series thereof that are performed in response to the suitability score 28 generated for the proposed quantum serverless function 24.

In some implementations, the execution action module 56 can include a file modifier 58. The file modifier 58 can dynamically modify the QI file 22 to modify the proposed quantum serverless function 24 based on the suitability score 28. For example, assume that the serverless metric 44 indicates that the proposed quantum serverless function 24 is poorly suited for serverless implementation within the quantum computing environment 10 because the proposed quantum serverless function 24 calls a large external library. The proposed function evaluator 36 can generate a function decision output 54 that indicates a decision to modify the proposed quantum serverless function 24 to remove the call to the large external library. Based on the function decision output 54 (and/or the suitability score 28) the execution action module 56 can utilize the file modifier 58 to generate QI file modifications 60. The QI file modifications 60 can modify the proposed quantum serverless function 24 to remove the call to the large external library. For example, the QI file modifications 60 may modify the proposed quantum serverless function 24 to call a smaller library that fulfills the same purpose. For another example, the QI file modifications 60 may “in-line” or copy the relevant portions of the external library and replicate the code within the QI file 22 so that the library does not need to be called.

For another example, assume that the execution metric 46 indicates that the proposed quantum serverless function 24 is poorly suited for execution within the quantum computing environment 10 because the proposed quantum serverless function 24 does not sufficiently limit the execution steps performed when the proposed quantum serverless function 24 is invoked. The proposed function evaluator 36 can generate a function decision output 54 that indicates a decision to modify the proposed quantum serverless function 24 to add limits to execution steps performed during invocation. Based on the function decision output 54 (and/or the suitability score 28) the execution action module 56 can utilize the file modifier 58 to generate QI file modifications 60. The QI file modifications 60 can modify the proposed quantum serverless function 24 to add limits or restrictions on the number of operations performed when the proposed quantum serverless function 24 is invoked. For example, if the proposed quantum serverless function 24 is a function that attempts to facilitate communications between quantum computing devices, the QI file modifications 60 may modify the proposed quantum serverless function 24 to cease communication attempts after a number of tries.

Additionally, or alternatively, in some implementations, the execution action module 56 can include an alternate computing environment selector 62. The alternate computing environment selector 62 can select an alternate computing environment for the proposed quantum serverless function 24 that is different than the quantum computing environment 10. For example, assume that the proposed function evaluator 36 generates the function decision output 54, which selects the alternate computing environment selector 62 based on the suitability score 28 being less than the threshold suitability score 48. In this instance, the threshold suitability score 48 can be specific to the set of quantum scoring criteria 32-1 (and included therein) and can represent a specific suitability for the quantum computing environment 10, rather than a suitability for quantum computing environments generally. As such, other sets of quantum scoring criteria 32 can include corresponding threshold suitability scores 48 for corresponding environments of the additional quantum computing environments 34.

The alternate computing environment selector 62 can generate quantum computing environment selection information 64. The quantum computing environment selection information 64 can select one of the additional quantum computing environments 34 for execution of the proposed quantum serverless function 24. In some implementations, the quantum computing environment selection information 64 can simply select the next environment in a sequence of environments formed by the additional quantum computing environments 34. For example, the quantum function evaluator 20 may iteratively evaluate the proposed quantum serverless function 24 in each of the additional quantum computing environments 34 until a suitable environment is found.

In some implementations, the alternate computing environment selector 62 can select one of the additional quantum computing environments 34 based on corresponding sets from the sets of quantum scoring criteria 32. Additionally, or alternatively, in some implementations, the alternate computing environment selector 62 can select one of the additional quantum computing environments 34 based on historical selection information descriptive of prior selections for the proposed quantum serverless function 24.

For example, assume that the suitability scores 28 generated for prior quantum serverless functions are stored in a repository (not illustrated) after being generated by the proposed function evaluator 36. Further assume that the runtime evaluator 42 stores associated information indicative of real-time performance after execution of the prior quantum serverless functions. The alternate computing environment selector 62 can identify a prior suitability score most similar to the suitability score 28. If the associated information from the runtime evaluator 42 indicates that real-time performance for the prior quantum serverless function was sufficient, the alternate computing environment selector 62 can select the quantum computing environment in which the prior quantum serverless function was executed from the additional quantum computing environments 34.

Additionally, or alternatively, in some implementations, the execution action module 56 can include a resource allocator 66. The resource allocator 66 can allocate additional resources (e.g., quantum computing resources, classical computing resources, etc.) to the quantum computing environment 10. Specifically, the resource allocator 66 can generate resource allocation instructions 68, which can cause allocation of additional resources to the quantum computing environment 10. Additionally, or alternatively, in some implementations, the resource allocator 66 can modify an existing allocation of resources within the quantum computing environment 10. The resource allocator 66 can allocate resources based on the suitability score 28. For example, assume that the execution metric 46 indicates that resources currently allocated to the quantum computing environment 10 are barely insufficient (or barely sufficient) for execution of the proposed quantum serverless function 24. In response, the resource allocator 66 can allocate additional resources to the quantum computing environment 10.

In some implementations, the function decision output 54 can select an execution action of the plurality of candidate execution actions based on a degree of difference between the suitability score 28 and the threshold suitability score 48. For example, if there is a relatively small difference between the suitability score 28 and the threshold suitability score 48, the proposed function evaluator 36 may decide that the difference can be mitigated by modifying the QI file with the file modifier 58 or by allocating additional resources with the resource allocator 66. If there is a larger difference, the proposed function evaluator 36 may instead decide to select a different computing environment (e.g., using the alternate computing environment selector 62).

Additionally, or alternatively, in some implementations, the execution action module 56 can include a function executer 70. The function executer 70 can generate execution instructions 72 that cause (or enable) execution of the proposed quantum serverless function 24 within the quantum computing environment 10. As the proposed quantum serverless function 24 may be event-driven and thus only executed in response to an event, the execution instructions 72 may enable the proposed quantum serverless function 24 for execution rather than affirmatively executing the proposed quantum serverless function 24.

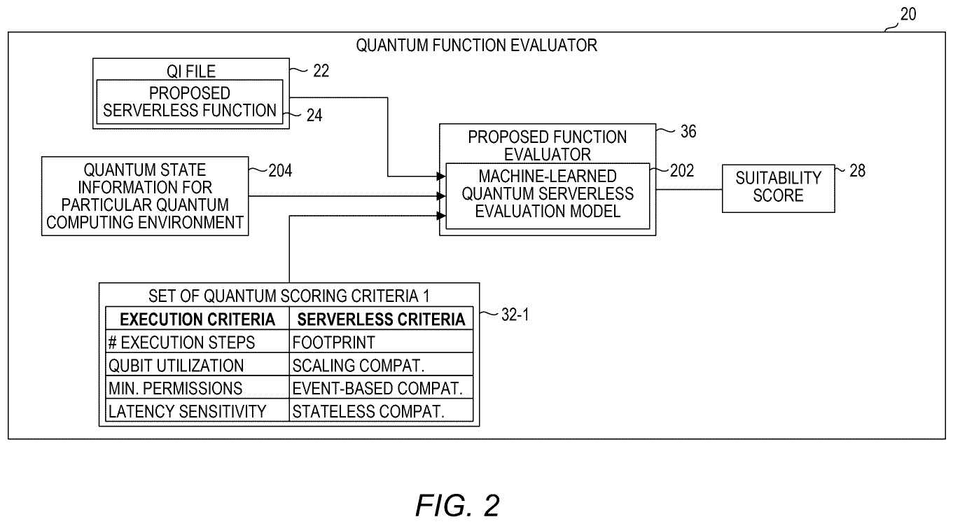

FIG. 2 is a data flow diagram for evaluating the proposed quantum serverless function 24 with a machine-learned model according to some implementations of the present disclosure. FIG. 2 will be discussed in conjunction with FIG. 1. More specifically, the quantum function evaluator 20 can include the proposed function evaluator 36 as described with regards to FIG. 1. In some implementations, the proposed function evaluator 36 can include a machine-learned quantum serverless evaluation model 202. The machine-learned quantum serverless evaluation model 202 can be a model trained to process a QI file 22 that describes a proposed quantum serverless function 24 to generate the suitability score 28.

The machine-learned quantum serverless evaluation model 202 can be any type or manner of machine-learned model, such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

The machine-learned quantum serverless evaluation model 202 can be trained based on prior examples of proposed quantum serverless functions and corresponding suitability scores. In such fashion, the machine-learned quantum serverless evaluation model 202 can be utilized to generate novel suitability scores for newly proposed functions.

To do so, the machine-learned quantum serverless evaluation model 202 can process the QI file 22 to generate the suitability score 28. Additionally, in some implementations, the machine-learned quantum serverless evaluation model 202 can process quantum state information 204 as a supplemental or contextual input. The quantum state information 204 can include real-time metrics for the quantum computing environment 10 (e.g., current resource usage, qubit locations, qubit file access permissions, historical performance information, etc.). Additionally, or alternatively, in some implementations, the machine-learned quantum serverless evaluation model 202 can process the set of quantum scoring criteria 38-1 that corresponds to the quantum computing environment 10. In such fashion, the machine-learned quantum serverless evaluation model 202 can be utilized to evaluate the set of quantum scoring criteria 38-1 based on the proposed quantum serverless function 24 and the quantum state information 204.

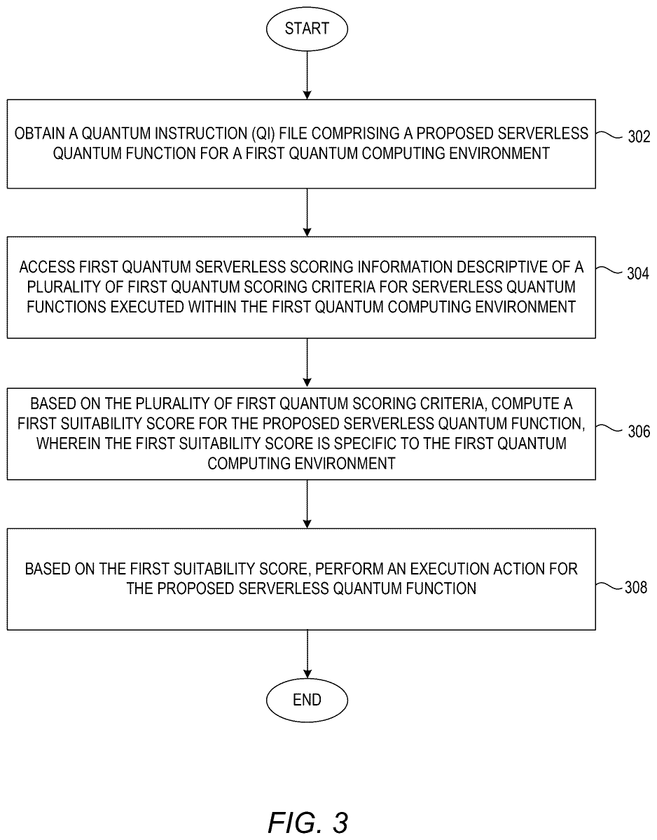

FIG. 3 is a flowchart diagram illustrating operations performed by the quantum computing system of FIG. 1 for dynamic evaluation of serverless functions for quantum computing environments, according to one example. Elements of FIG. 1 are referenced in describing FIG. 3 for the sake of clarity. In FIG. 3, operations begin with a processor device of a computing device, computing system, network node, etc., such as the processor device(s) 14 of the quantum computing system 12 of FIG. 1. The processor device(s) 14 are to obtain a QI file 22 that includes a proposed serverless quantum function 24 for a particular quantum computing environment 10 (block 302). The processor device(s) 14 are further to access quantum serverless scoring information 30 descriptive of a plurality of quantum scoring criteria 32-1 for serverless quantum functions executed within the particular quantum computing environment 10 (block 304). The processor device(s) 14 are further to, based on the plurality of quantum scoring criteria 32-1, compute a suitability score 28 for the proposed serverless quantum function 24, wherein the suitability score 28 is specific to the particular quantum computing environment 10 (block 306). The processor device(s) 14 are further to, based on the suitability score 28, perform an execution action for the proposed serverless quantum function 24 (block 308).

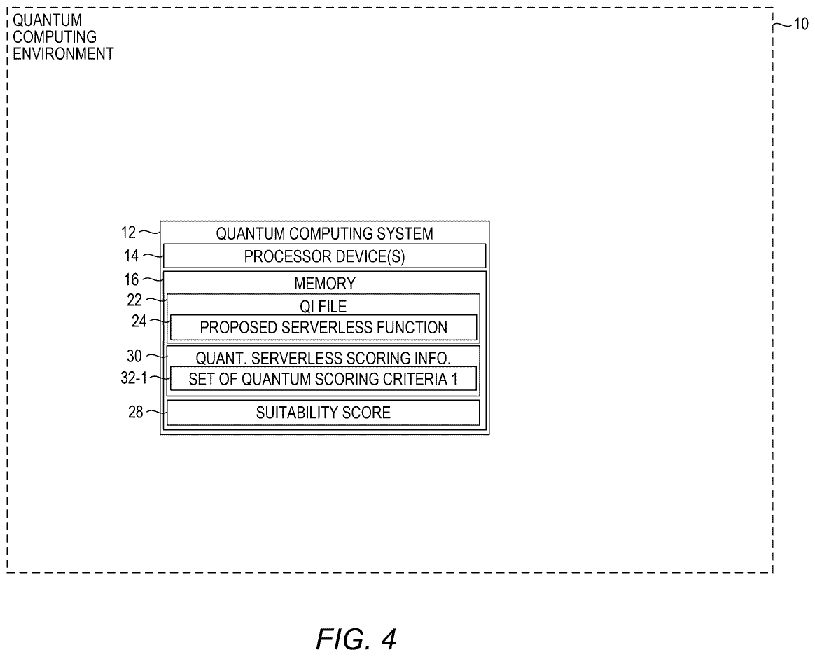

FIG. 4 is a block diagram of the computing device of FIG. 1 for dynamic evaluation of serverless functions for quantum computing environments, according to one example. Elements of FIG. 1 are referenced in describing FIG. 4 for the sake of clarity. In the example of FIG. 4, the quantum computing system 12 includes a memory 16 and processor device(s) 14 coupled to the memory 16. The processor device(s) 14 are to obtain a QI file 22 that includes a proposed serverless quantum function 24 for a particular quantum computing environment 10. The processor device(s) 14 are further to access quantum serverless scoring information 30 descriptive of a plurality of quantum scoring criteria 32-1 for serverless quantum functions executed within the particular quantum computing environment 10. The processor device(s) 14 are further to, based on the plurality of quantum scoring criteria 32-1, compute a suitability score 28 for the proposed serverless quantum function 24, wherein the suitability score 28 is specific to the particular quantum computing environment 10. The processor device(s) 14 are further to, based on the suitability score 28, perform an execution action for the proposed serverless quantum function 24.

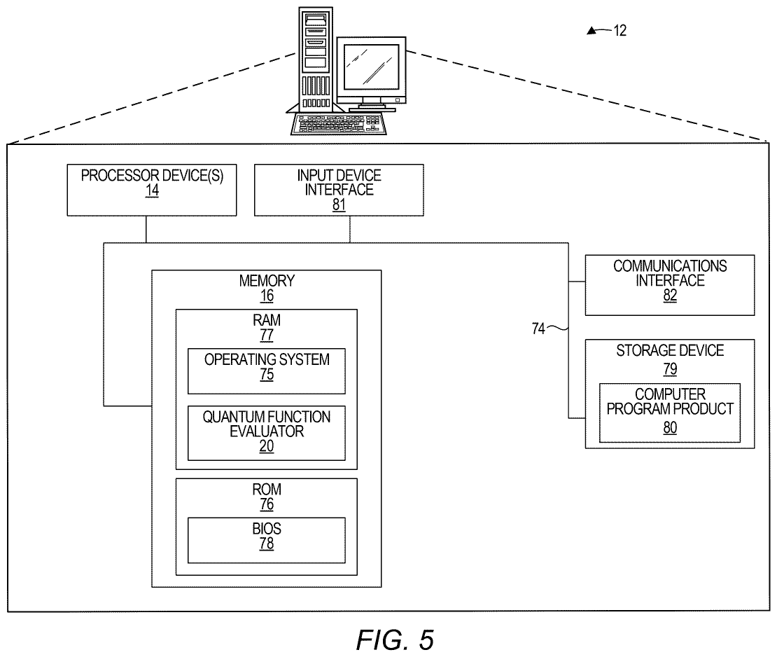

FIG. 5 is a block diagram of the quantum computing system 12 suitable for implementing examples according to one example. The quantum computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The quantum computing system 12 includes the processor device(s) 14, the memory 16, and a system bus 74. The system bus 74 provides an interface for system components including, but not limited to, the memory 16 and the processor device(s) 14. The processor device(s) 14 can be any commercially available or proprietary processor.

The system bus 74 may be any of several types of bus structures that may further interconnect to a memory bus (with or without a memory controller), a peripheral bus, and/or a local bus using any of a variety of commercially available bus architectures. The memory 16 may include non-volatile memory 76 (e.g., read-only memory (ROM), erasable programmable read-only memory (EPROM), electrically erasable programmable read-only memory (EEPROM), etc.), and volatile memory 77 (e.g., random-access memory (RAM)). A basic input/output system (BIOS) 78 may be stored in the non-volatile memory 76 and can include the basic routines that help to transfer information between elements within the quantum computing system 12. The volatile memory 77 may also include a high-speed RAM, such as static RAM, for caching data.

The quantum computing system 12 may further include or be coupled to a non-transitory computer-readable storage medium such as the storage device 79, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 79 and other drives associated with computer-readable media and computer-usable media may provide non-volatile storage of data, data structures, computer-executable instructions, and the like.

A number of modules can be stored in the storage device 79 and in the volatile memory 77, including an operating system 75 and one or more program modules, such as the quantum function evaluator 20, which may implement the functionality described herein in whole or in part. All or a portion of the examples may be implemented as a computer program product 80 stored on a transitory or non-transitory computer-usable or computer-readable storage medium, such as the storage device 79, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the quantum function evaluator 20 in the volatile memory 77, may serve as a controller, or control system, for the quantum computing system 12 that is to implement the functionality described herein.

Because the quantum function evaluator 20 is a component of the quantum computing system 12, functionality implemented by the quantum function evaluator 20 may be attributed to the quantum computing system 12 generally. Moreover, in examples where the quantum function evaluator 20 comprises software instructions that program the processor device(s) 14 to carry out functionality discussed herein, functionality implemented by the quantum function evaluator 20 may be attributed herein to the processor device(s) 14.

An operator, such as a user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 81 that is coupled to the system bus 74 but can be connected by other interfaces such as a parallel port, an Institute of Electrical and Electronic Engineers (IEEE) 1394 serial port, a Universal Serial Bus (USB) port, an IR interface, and the like. The quantum computing system 12 may also include the communications interface 82, such as an Ethernet transceiver and/or a Wi-Fi transceiver, or the like, suitable for communicating with the network as appropriate or desired. The quantum computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a quantum computing system comprising one or more processor devices, a Quantum Instruction (QI) file comprising a proposed serverless quantum function for a first quantum computing environment;
accessing, by the quantum computing system, first quantum serverless scoring information descriptive of a plurality of first quantum scoring criteria for serverless quantum functions executed within the first quantum computing environment;
based on the plurality of first quantum scoring criteria, computing, by the quantum computing system, a first suitability score for the proposed serverless quantum function, wherein the first suitability score is specific to the first quantum computing environment; and
based on the first suitability score, performing, by the quantum computing system, an execution action for the proposed serverless quantum function.

2. The method of claim 1, wherein performing the execution action for the proposed serverless quantum function comprises:
comparing, by the quantum computing system, the first suitability score and a first threshold suitability score.

3. The method of claim 2, wherein the first suitability score comprises an execution metric and a serverless metric; and
wherein comparing the first suitability score and the first threshold suitability score comprises:
comparing, by the quantum computing system, the execution metric with a threshold execution metric of the first threshold suitability score; and
comparing, by the quantum computing system, the serverless metric with a threshold serverless metric of the first threshold suitability score.

4. The method of claim 3, wherein comparing the execution metric with the threshold execution metric of the first threshold suitability score comprises:
determining that the serverless metric of the first suitability score is less than the threshold serverless metric of the first threshold suitability score.

5. The method of claim 3, wherein comparing the execution metric with the threshold execution metric of the first threshold suitability score comprises:
determining, by the quantum computing system, that the execution metric of the first suitability score is less than the threshold execution metric of the first threshold suitability score.

6. The method of claim 5, wherein performing the execution action for the proposed serverless quantum function comprises:
accessing, by the quantum computing system, second quantum serverless scoring information descriptive of a plurality of second quantum scoring criteria for serverless quantum functions executed within a second quantum computing environment;
based on the plurality of second quantum scoring criteria, computing, by the quantum computing system, a second suitability score for the proposed serverless quantum function, wherein the second suitability score is specific to the second quantum computing environment; and
based on a comparison between the second suitability score and a second threshold suitability score, executing, by the quantum computing system, the QI file within the second quantum computing environment.

7. The method of claim 1 wherein performing the execution action for the proposed serverless quantum function comprises:
allocating, by the quantum computing system, quantum computing resources to the first quantum computing environment.

8. The method of claim 1 wherein performing the execution action for the proposed serverless quantum function comprises:
outputting, by the quantum computing system, information indicating that the proposed serverless quantum function is unsuitable for execution within the first quantum computing environment.

9. The method of claim 1, wherein performing the execution action for the proposed serverless quantum function comprises:
computing, by the quantum computing system, a plurality of modifications for the QI file, wherein the plurality of modifications modify the proposed serverless quantum function to be a server-based quantum function; and
executing, by the quantum computing system, the QI file within the first quantum computing environment.

10. The method of claim 1, wherein performing the execution action for the proposed serverless quantum function comprises:
executing, by the quantum computing system, the QI file within the first quantum computing environment.

11. The method of claim 10, wherein executing the QI file within the first quantum computing environment comprises:
allocating, by the quantum computing system, quantum computing resources to the first quantum computing environment based at least in part on the first suitability score.

12. The method of claim 1, wherein performing the execution action for the proposed serverless quantum function comprises:
outputting, by the quantum computing system, information indicating that the proposed serverless quantum function is suitable for execution within the first quantum computing environment.

13. The method of claim 1, wherein the plurality of first quantum scoring criteria comprises at least one of:
a degree of quantum computing resource usage associated with the proposed serverless quantum function;
qubit file access required by the proposed serverless quantum function;
a number of execution steps associated with the proposed serverless quantum function; or
a number of qubits necessary to execute the proposed serverless quantum function.

14. A quantum computing system comprising:
one or more processor devices to:
obtain a Quantum Instruction (QI) file comprising a proposed serverless quantum function for a first quantum computing environment;
access first quantum serverless scoring information descriptive of a plurality of first quantum scoring criteria for serverless quantum functions executed within the first quantum computing environment;
based on the plurality of first quantum scoring criteria, compute a first suitability score for the proposed serverless quantum function, wherein the first suitability score is specific to the first quantum computing environment; and
based on the first suitability score, perform an execution action for the proposed serverless quantum function.

15. The quantum computing system of claim 14, wherein, to perform the execution action for the proposed serverless quantum function, the one or more processor device are further to:
compare the first suitability score and a first threshold suitability score.

16. The quantum computing system of claim 15, wherein the first suitability score comprises an execution metric and a serverless metric; and
wherein, to compare the first suitability score and the first threshold suitability score, the one or more processor devices are further to:
compare the execution metric with a threshold execution metric of the first threshold suitability score; and
compare the serverless metric with a threshold serverless metric of the first threshold suitability score.

17. The quantum computing system of claim 16, wherein, to compare the execution metric with the threshold execution metric of the first threshold suitability score, the one or more processor devices are further to:
determine that the execution metric of the first suitability score is less than the threshold execution metric of the first threshold suitability score.

18. The quantum computing system of claim 17, wherein, to perform the execution action for the proposed serverless quantum function, the one or more processor devices are further to:
access second quantum serverless scoring information descriptive of a plurality of second quantum scoring criteria for serverless quantum functions executed within a second quantum computing environment;
based on the plurality of second quantum scoring criteria, compute a second suitability score for the proposed serverless quantum function, wherein the second suitability score is specific to the second quantum computing environment; and
based on a comparison between the second suitability score and a second threshold suitability score, execute the QI file within the second quantum computing environment.

19. The quantum computing system of claim 14 wherein, to perform the execution action for the proposed serverless quantum function, the one or more processor devices are further to:
allocate quantum computing resources to the first quantum computing environment.

20. A non-transitory computer-readable storage medium that includes executable instructions to cause one or more processor devices of a quantum computing system to:
obtain a Quantum Instruction (QI) file comprising a proposed serverless quantum function for a first quantum computing environment;
access first quantum serverless scoring information descriptive of a plurality of first quantum scoring criteria for serverless quantum functions executed within the first quantum computing environment;
based on the plurality of first quantum scoring criteria, compute a first suitability score for the proposed serverless quantum function, wherein the first suitability score is specific to the first quantum computing environment; and
based on the first suitability score, perform an execution action for the proposed serverless quantum function.
